(19) United States
(12) Patent Application Publication
(10) Pub. No.: US 2017/0202651 A1
(43) Pub. Date: Jul. 20, 2017

(54) DENTAL PROSTHESIS MODIFIED WITH FILM AND HAVING IMPROVED PROPERTIES

(71) Applicant: HERAEUS KULZER GMBH, Hanau (DE)

(72) Inventors: Karl-Heinz RENZ, Alzenau (DE); Frank-Uwe STANGE, Langenargen (DE); Marlene NIESE, Kressbronn (DE)

(73) Assignee: Heraeus Kulzer GmbH, Hanau (DE)

(21) Appl. No.: 15/321,315

(22) PCT Filed: Jun. 26, 2015
(86) PCT No.: PCT/EP2015/064610

§ 371 Date: Dec. 22, 2016

(30) Foreign Application Priority Data
Jun. 27, 2014 (DE) 10 2014 109 098.5

(51) Int. Cl. A61C 13/09; A61C 5/73; A61C 13/00; A61C 13/08; A61C 13/20; A61C 5/77; A61C 5/20; A61C 13/271

(52) U.S. Cl. CPC A61C 13/09; A61C 5/20; A61C 5/73; A61C 13/26; A61C 13/082; A61C 13/20; A61C 5/77; A61C 13/0006

(57) ABSTRACT

The invention relates to a dental prosthesis, in particular prefabricated tooth replacements, whereby a layer of a film is integrated into the dental prosthesis. Preferably, the dental prosthesis is built up layer-wise, whereby the prosthesis comprises an inner tooth portion, a film on the inner tooth portion, and a further tooth portion outside on the film, such as a veneer and/or incisor shell. The method for producing said dental prostheses is also a subject matter of the invention.

The invention relates to a dental prosthesis, in particular prefabricated tooth replacements, whereby a layer of a film is integrated into the dental prosthesis. Preferably, the dental prosthesis is built up layer-wise, whereby the prosthesis comprises an inner tooth portion, a film on the inner tooth portion, and a further tooth portion outside on the film, such as a veneer and/or incisor shell. The method for producing said dental prostheses is also a subject matter of the invention.

Thus far, prefabricated tooth replacements are available as versions made of different materials. Usually, prefabricated tooth replacements are based on acrylate or methacrylate polymers that can be produced with or without filling agents.

Said teeth show good stability with respect to everyday mechanical stresses. However, in the past 10 years, prefabricated tooth replacements have been used increasingly not only in hybrid prostheses or telescopic prostheses as replaceable dental restorations and total prostheses, but also for the production of implant-retained dental restorations. The mechanical stresses acting on implant-retained dental restorations are higher. Moreover, there is a tendency to experience improper burdening. As a result, fractures occur occasionally, in particular in the region of the front teeth. These fractures reduce the stress on the other components of the dental restoration, such as the actual implants, and are no essential problem as such. However, it is a problem if parts of the dental restoration break off or chip.

It was therefore the object to provide dental prostheses that can prevent chipping of parts of the prosthesis after formation of a fracture at least for a certain period of time. In particular, teeth, such as prefabricated tooth replacements, shall be provided that show no chipping of parts of the tooth after formation of a fracture. Moreover, a method for producing said dental prostheses was to be provided.

The object is met by a dental prosthesis according to claim 1 and a method according to claim 9.

The subject matter of the invention is a dental prosthesis into which at least one layer of a film is integrated. Another subject matter of the invention is a prosthesis, in particular a tooth, a veneer, bridge or crown that comprises an integrated film in buccal or labial location. Further preferably, the tooth comprises, alternatively or additionally, an integrated film in occlusal and/or proximal location. Dental prostheses are also preferred, in particular in the form of teeth that comprise the layer of film in integrated manner, whereby the layer of film is preferably arranged: a) buccal, b) buccal and mesial and/or occlusal, c) occlusal, d) occlusal buccal, e) incisal, f) incisal and buccal, g) buccal, occlusal, and proximal, h) incisal and proximal are also preferred. Preferably, the film is provided with a further tooth layer, such as an external tooth layer. The external tooth layer can be a veneer analogous to a dentine layer.

A prosthesis according to the invention shall be understood to be a prosthetic restoration that can be a prosthetic dental form body. The prosthetic restoration can be a part of a fixed dental restoration or a part of a removable dental restoration, such as a hybrid prosthesis.

Using an integrated tough-elastic and/or thermoplastic film between the layers of the dental prosthesis, such as a tooth, can prevent parts of the prosthesis from detaching after a fracture has formed.

Moreover, artificial teeth and pre-fabricated veneers have a certain residual transparency due to the limited thickness. Said transparency can be a problem if backgrounds, such as metallic frameworks, are to be covered. These problems can be prevented through the use of the film according to the invention by integrating tinted, opaque, milky or turbid films in the dental prostheses. Another way of varying the colour as desired is given by the positioning of the film inside the prosthesis. Accordingly, the film can be provided right underneath the veneer, such as an outer further tooth layer, or can be integrated into the veneer itself or between two further tooth layers.

Accordingly, the subject matter of the invention is a dental prosthesis comprising an integrated film, whereby the film is integrated underneath and/or on a further dental layer. According to an alternative, the film is therefore integrated underneath and/or inside the veneer. According to the invention, a film contacts only inner surfaces of the prosthesis.

An integrated film shall be understood to mean a film embedded into the prosthesis. In particular, the film is situated, at least in part, between two tooth layers or one tooth portion and one tooth layer. Preferably, the film is situated, at least in part, between the inner tooth portion and the further tooth layer. In this case, the further tooth layer may be the outer tooth layer and/or incisor shell. In this alternative, the film is situated underneath a veneer on the tooth core (inner to the beach and).

The film can just as well be situated between a second further tooth layer and an outer tooth layer. In this case, the film is provided inside the veneer.

According to a further alternative, a dental prosthesis can comprise one, two or more films, in particular between the inner tooth portion and a further tooth layer and between a second further tooth layer and an outer tooth layer, such as in a veneer. Likewise, the dental prosthesis can comprise, in addition, a non-integrated film as part of the external surface of the prosthesis.

Another subject matter of the invention is a dental prosthesis that is at least a part of a dental restoration, in particular a single tooth, preferably a prefabricated tooth replacement, or a bridge, in particular a multi-unit bridge. A multi-unit bridge can comprise one, two, three or four teeth. Likewise, the prosthesis can comprise a crown, preferably, the inner tooth portion is present in the form of a coping on which the film can be arranged. A veneer can be applied to the film as further tooth layer. If the prosthesis is present as veneer, the film can be present between the inner tooth portion in the form of a shell and a further tooth portion as outer incisor shell.

Another subject matter of the invention is a prosthesis that is designed layer-by-layer, and

comprising at least one part of an inside layer of a film. Preferably, the dental prosthesis is designed layer-by-layer as follows (i) the inner tooth portion comprises PMMA and/or PEMA, (ii) the film comprises a tough-elastic and/or thermoplastic film, such as PVC film, that can be transparent or opaque, and, optionally, can be tinted, and (iii) the at least one further tooth layer comprises PMMA, PEMA, veneer composite, in particular light-curing veneer composite, or a veneer ceramics. According to the invention, the tough-elastic and/or thermoplastic film is a film made of an organic polymeric material.

Another subject matter of the invention is a prosthesis selected from a tooth with an integrated film, whereby the tooth comprises at least three portions, namely (i) inner tooth portion, in particular comprising multiple tooth layers, (ii) film layer, and (iii) at least one further tooth layer. Another subject matter of the invention is a bridge comprising at least two teeth, whereby the teeth each comprise an inner tooth portion that is provided, at least in part, with a film layer, and the film layer is covered, at least in part, by a further tooth layer, such as a veneer.

According to an embodiment of the dental prosthesis of the invention, the (i) inner tooth portion can correspond to the dentine portion and the (iii) at least one further tooth layer can correspond to the enamel portion. The film layer is preferably situated between the dentine portion and the enamel portion in this variant of an embodiment.

In this context, the (i) inner tooth portion can preferably comprise multiple tooth layers. The inner tooth portion in the prefabricated tooth replacement corresponds to the tooth core that is analogous to the enamel. The tooth core comprises a, preferably basal, lumen for attachment of the prosthesis in the mouth of the patient. The (iii) at least one further tooth layer can comprise one tooth layer (1-tooth layer) up to a multitude of tooth layers (n-tooth layers), such as one further tooth layer, a second further tooth layer, etc., whereby one of the further tooth layers corresponds to the outer tooth layer. The veneer can comprise an outer tooth layer or a further tooth layer, a film as well as an outer further tooth layer. The veneer can correspond to the dentine layer in the natural tooth.

Moreover, the prosthesis can comprise (i) an inner tooth portion, in particular designed to be monolithic or layer-wise, comprising at least one polymer of an acrylate, such as alkylacrylate, in particular PMMA, preferably copolymers of acrylates and/or (ii) the at least one film layer comprising a tough-elastic and/or thermoplastic film, whereby the film can be based on the following materials, PVC, acrylate-based film, PE, PP, LDPE, HDPE, LDPP; HDPP, PUR, polycarbonate and/or (iii) the at least one further tooth layer comprises a polymer of an acrylate, such as alkylacrylate, in particular PMMA, copolymers of acrylates, veneer composite, dental veneer ceramics, such as zirconium dioxide.

The film layer can preferably have a layer thickness of 50 to 1,000 μm (micrometre), with 50 to 250 μm being preferred and 50 to 170 μm being more preferred.

The inner tooth portion preferably comprises acrylates or methacrylates, optionally with organic and/or inorganic filling agents. Common filling agents comprise silicon dioxide, zirconium dioxide, dental glasses.

In the scope of the production of artificial teeth layer-by-layer, a film layer can be integrated into a tooth, optionally at least one further film layer can be introduced and integrated into the tooth. The layer can be applied at any place in the tooth, optionally, in addition, on the surface.

Suitable film materials are subject to the following criteria. The film should preferably be tough-elastic, connectable to PMMA, either via solution processes or via a chemical bond, such as chemical reactions or, if applicable, by surface treatments, such as plasma coatings. Optionally, film layers can be used tinted, tinted like tooth shades and/or opaque. In an experiment, a modified PVC film with a thickness of 140 μm and a melting range of 120 to 170° C. was used. However, other film materials that connect homogeneously to the surrounding tooth material are feasible just as well.

The modification of the prosthetic restoration did not affect the aesthetic properties and did not reduce the strength of the tooth. The product meets the materials requirements of EN ISO 22112.

Another subject matter of the invention is a dental prosthesis, whereby (ii) the film layer comprises a transparent, milky or opaque film, which, optionally, can be tinted in addition.

Preferably, the film can be tinted, in particular the film has a yellow hue.

Moreover, the dental prosthesis can comprise a film that is plasma-treated or chemically-modified on the surface. Preferably, the film can be connected chemically covalent to the inner tooth portion and/or to the further tooth portion. A connection can preferably take place by means of a surface-modified film that binds covalently to the inner tooth portion and/or to the further tooth portion by means of thermal activation.

Another subject matter of the invention is a method for producing a dental prosthesis, as well as a dental prosthesis obtainable according to said method, comprising the steps of

1) Providing a film and 2) integrating the film into the prosthesis, preferably the film is integrated into the prosthesis by

a) (i) producing an inner tooth portion in a first step, (ii) applying and affixing a film at least in part to the inner tooth portion or arranging a film on the inner tooth portion in a subsequent step, and, optionally, (iii) applying at least one further tooth layer, at least in part, to the film and, optionally, to the regions of the inner tooth portion not provided with film, or

b) (i) providing at least one further tooth layer, (ii) arranging, in particular applying, a film on the further tooth layer, (iii) arranging an inner tooth portion on the film, or

c) (i) providing, in particular arranging, a film and (ii) surrounding the film with the inner tooth portion and/or the at least one further tooth layer. In variant c) of the method, the film is preferably clamped into a negative of a prosthesis mould and subsequently surrounded with curable and/or polymerisable prosthesis material.

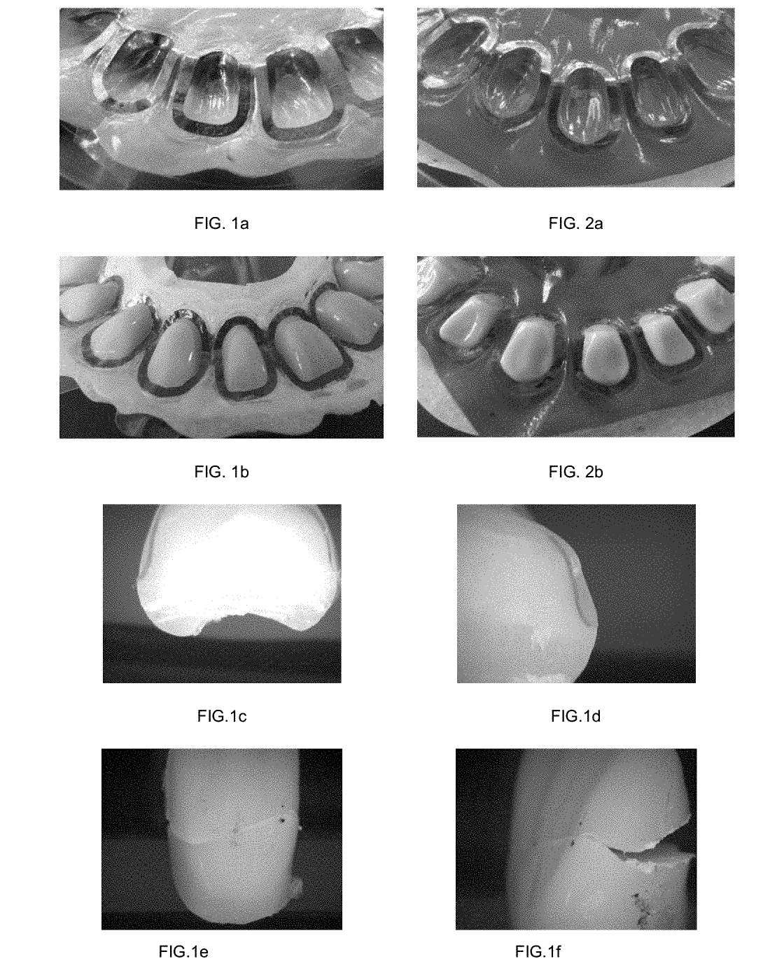

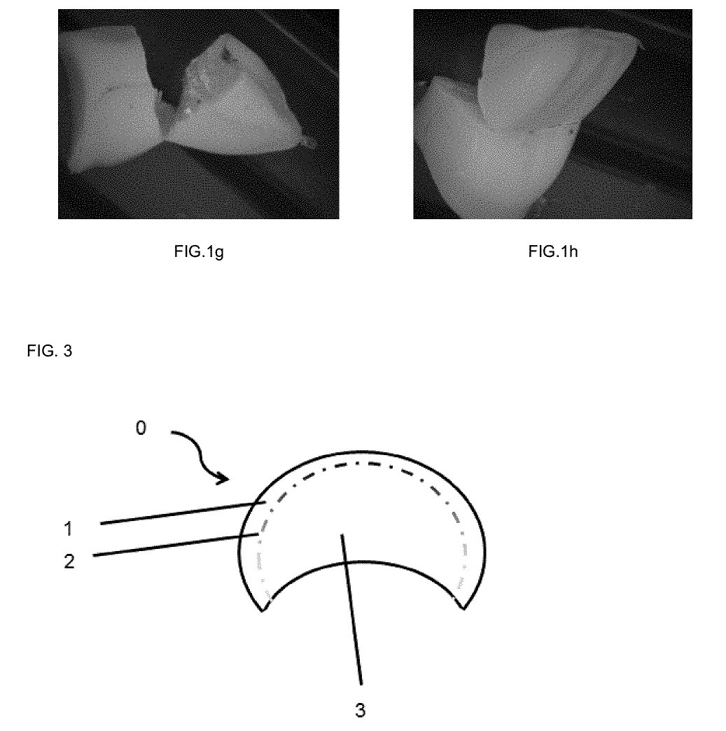

According to alternative c) (i) arranging the film involves the film, in particular a film made of organic polymers, particularly preferably a web of film, which can be clamped into a hollow mould, in particular between the negative moulds of the hollow mould. In this context, it is a particular advantage of the method according to the invention that the film or web of film or film web does not need to be cut to size, but rather can project out of the hollow mould and can be clamped as an entire web of film or film web, in particular off the reel, between the corresponding negative moulds of a multitude of hollow moulds of prefabricated tooth replacements, as depicted in FIGS. 1a, 1b, 2a, and 2b. According to the inventive method, the film does not need to be deep-drawn. A multitude of pre-fabricated prostheses, in particular prefabricated teeth replacements, can be produced according to the inventive method through integration of a film.

According to a further alternative, the method comprises the steps of: d) (i) producing at least one part of an inner tooth portion in the first step, (ii) applying and affixing a film at least in part to said part of the inner tooth portion or arranging a film on said part of the inner tooth portion in a subsequent step, and, optionally, (iii) applying at least one further part of the inner tooth portion to the film and, optionally, to the regions of said part of the inner tooth portion not provided with film.

Preferably, the method can comprise the following steps of (i) producing an inner tooth portion in a first step, (ii) applying and affixing a film at least in part to the inner tooth portion or arranging a film on the inner tooth portion in a subsequent step, and, optionally, (iii) applying at least one further tooth layer, at least in part, to the film and, optionally, to the regions of the inner tooth portion not provided with film. The application of the film can preferably take place by thermal means.

The outermost further tooth layer preferably corresponds to the veneer or, alternatively, the veneer corresponds to the following design: a further tooth layer, a film layer, a further tooth layer that corresponds to the outer tooth layer.

According to an alternative, a tooth according to the invention can be produced by clamping at least one film in a casting mould and subsequently introducing the polymerisable dental polymer mixture into the casting mould while applying a pressure.

Accordingly, for example a tooth cement, in particular comprising PMMA, can be prepared by mixing and can be injected under pressure into a mould in order to produce the inner tooth portion. The tooth cement cures afterwards. Preferably, the film can be appropriately clamped in the mould such that the film is integrated into the tooth cement and simultaneously the design of: inner tooth portion, film, and at least one further tooth layer, is formed.

Alternatively, a film can be applied to the inner tooth portion. This can take place, for example, by applying a film to at least one part of an inner tooth portion, and, optionally, heating the film.

Accordingly, at least one part (i) of the inner tooth portion can be produced in the method according to the invention from a composition, in particular a polymerisable composition, comprising 50 to 90% by weight powdered polymers such as PMMA, preferably 60 to 70% by weight PMMA, in particular PMMA bead polymers, and 10 to 50% by weight monomers, preferably 30 to 40% by weight monomers, whereby the monomers comprise, in particular, (meth)acrylates, derivatives of (meth)acrylates and/or cross-linkers, such as di- and multi-functional (meth)acrylates. Glycoldimethacrylate is a preferred multiple cross-linker. Preferably, the composition is a polymerisable tooth cement, preferably a composition being radically polymerisable, more preferably a composition that can be polymerised by thermal means. Preferably, the composition comprises initiators for a thermally-induced radical polymerisation. Preferred initiators comprise peroxides such as dibenzoylperoxide (BPO), or also N,N-azobisisobutyronitril=2,2′-azo-di(isobutyronitrile) (AIBN).

Alternatively, the inner tooth portion, at least one tooth layer or the veneer can be produced or is obtainable by polymerising 0 to 50% by weight organic or inorganic filling agents, 50 to 90% by weight PMMA, 10 to 50% by weight monomers, in particular, (meth)acrylates, derivatives of (meth)acrylates and/or cross-linkers, whereby the total composition adds up to 100% by weight, whereby the organic and inorganic filling agents comprise powdered polymers, in particular with the exception of PMMA. The inorganic filling agents can comprise dental glasses, glass ceramics, metal oxides such as silicon dioxide, zirconium dioxide, ytterbium-, barium-, and strontium-containing inorganic filling agents.

Preferably, the inner tooth layer and the further tooth layer also, each independently, can be produced from the above-mentioned composition. For this purpose, the composition is preferably introduced into a negative mould in the form of at least one part of an inner tooth portion or a tooth layer and polymerised, at least in part, whereby, optionally, a separating layer, such as a separating film, is being used.

Subsequently, the separating layer can be removed and (ii) replaced by the film. In a further step (iii) further polymerisable composition is introduced into the negative mould in order to form a further part of the inner tooth portion or of a tooth layer and to polymerise it. The polymerisation preferably takes place at 2 to 10 bar, preferably at 3 to 5 bar, and at 90 to 150° C., preferably at 90 to 120° C.

According to an alternative, (ii) the inner tooth layer comprises a polymer of an acrylate, such as alkylacrylates, in particular PMMA, preferably copolymers of (alkyl)acrylates and/or monomers comprising (meth)acrylate and/or (iii) the at least one further tooth layer comprises a polymer of an acrylate, such as (alkyl)acrylate, in particular PMMA, copolymers of alkylacrylates and/or monomers comprising (meth)acrylates or dental veneer composite, in particular a light-curing veneer composite, dental veneer ceramics, zirconium dioxide.

The inner tooth portion, the at least one tooth layer or further tooth layers and/or the veneer preferably comprise the following polymers, copolymers optionally comprising cross-linkers or are based on the polymerisation products of the following monomers and preferably the following powdered polymers, such as (alkyl)acrylates, such as PMMA, PEMA and/or a copolymer based on (meth)acrylates and cross-linkers such as UDMA, bis-GMA, EGDMA. Alternatively, inorganic filling agents can additionally be present.

The inner tooth portion or the tooth layers are preferably produced from a polymerisable composition comprising 50 to 90% by weight powdered polymer, such as PMMA, and 10 to 50% by weight monomers, in particular comprising (meth)acrylates, derivatives of (meth)acrylates.

Conceivable as monomer is at least one monomer or a mixture of monomers comprising a) methylmethacrylate, ethylmethacrylate, propylmethacrylate, butylmethacrylate, n-hexylmethacrylate, 2-phenoxyethylmethacrylate, isobornylmethacrylate, isodecylmethacrylate, polypropylene-glycol-mono-methacrylate, tetrahydrofuryl-methacrylate, methylacrylate, ethylacrylate, propylacrylate, butylacrylate, n-hexylacrylate, 2-phenoxyethylacrylate, isobornylacrylate, isodecylacrylate, polypropylene-glycol-mono-acrylate, tetrahydrofurylacrylate, hydroxyethylacrylate, hydroxypropylacrylate, hydroxyethyl methacrylate, hydroxypropylmethacrylate, benzyl-, furfuryl- or phenyl(meth)acrylate, a mixture containing at least one of said (meth-)acrylates and/or copolymers comprising one or at least two of said monomers, and/or

b) di- and/or multi-cross-linkers comprising 1,4-butanediol-dimethacrylate (1,4-BDMA) or pentaerythritol-tetraacrylate, bis-GMA-monomer (bisphenyl-A-glycidyl-methacrylate), triethyleneglycoldimethacrylate (TEGDMA), and diethyleneglycoldimethacrylate (DEGMA), tetraethyleneglycoldi(meth)acrylate, decanedioldi(meth)acrylate, dodecanedioldi(meth)acrylate, hexyldecanedioldi(meth)acrylate, trimethylolpropanetri(meth)acrylate, pentaerythritoltetra(meth)acrylate as well as butanedioldi(meth)acrylate, ethyleneglycol-di(meth)acrylate, polyethyleneglycol-di(meth)acrylates, ethoxylated/propoxylated bisphenol-A-di(meth)acrylates, a mixture containing at least one of said (meth-)acrylates and/or copolymers comprising one or at least two of said monomers.

Preferably conceivable as polymers, in particular as powdered polymers, in particular as bead polymer, are polymeric particles comprising polymers in the form of polymer powder comprising polyalkyl(meth)acrylates that are optionally cross-linked and are present as homo- or copolymers, whereby the polymers are based on at least one of the monomers comprising a (meth)acrylate group selected from methylmethacrylate, ethyl methacrylate, propyl methacrylate, butylmethacrylate, n-hexyl methacrylate, 2-phenoxyethylmethacrylate, isobornylmethacrylate, isodecylmethacrylate, polypropylene-glycol-mono-methacrylate, tetrahydrofuryl-methacrylate, methylacrylate, ethylacrylate, propylacrylate, butylacrylate, n-hexylacrylate, 2-phenoxyethylacrylate, isobornylacrylate, isodecylacrylate, polypropylene-glycol-mono-acrylate, tetrahydrofuryl-acrylate, hydroxyethylacrylate, hydroxypropylacrylate, hydroxyethylmethacrylate, hydroxypropylmethacrylate, a mixture containing at least one of said (meth-)acrylates and/or copolymers comprising one or at least two of said monomers, polyamide particles, polyamide fibres, whereby polymethylmethacrylate (PMMA) is particularly preferred. Moreover, the polymeric particles can also comprise mixtures of dental monomers, such as, e.g., MMA, and, in addition, at least one cross-linker.

Powdered components comprising polymethylmethacrylate (PMMA) beads as polymeric particles and/or chipped polymers as well as copolymers comprising, as comonomers that have been polymerised into them, styrene, alpha-methylstyrene, vinyltoluene, substituted vinyltoluenes such as vinylbenzylchlorides, vinylhalogenides such as vinylchloride, vinylesters such as vinylacetate, heterocyclic vinyl compounds such as 2-vinylpyridine, vinylacetate, and vinylpropionate, butadiene, isobutylene, 2-chlorobutadiene, 2-methylbutadiene, vinylpyridine, cyclopentene, (meth)acrylic acid esters such as methylmethacrylate, butyl methacrylate, butylacrylate, and hydroxyethylmethacrylate, moreover acrylonitrile, maleic acid, and maleic acid derivatives such as, for example, maleic acid anhydride, fumaric acid and fumaric acid derivatives such as fumaric acid esters, acrylic acid, methacrylic acid, aryl(meth)acrylates such as benzylmethacrylate or phenylmethacrylate as well as, optionally, mixtures of said comonomers are particularly preferred.

Moreover, the invention preferably comprises an internal tooth portion, the at least one tooth layer, and the at least one further tooth layer, made of a prosthetic material which is obtainable by reacting, preferably, monomers and powdered polymers in the presence of at least one initiator or initiator system for auto-polymerisation, radiation curing, in particular UV curing, hot polymerisation or dual curing.

According to a particularly preferred alternative of the method, a PVC film, in particular having a layer thickness of 50 to 170 μm, preferably approximately 140 μm, is being applied to an inner tooth portion and heated to the melting range. Films that are preferably used in this context have a melting range of 120° C. to 170° C. In general, the melting range of the film material should be below the melting range of the material of the inner tooth portion and/or of the at least one further tooth layer, if the film is applied separately by means of a thermal procedure. If the film is clamped into a mould and the yet-to-be-polymerised tooth cement is filled into the mould, the melting temperature of the film should be higher than the polymerisation temperature. Accordingly, another subject matter of the invention is a method, in which the film has a melting range of 120 to 170° C. and the film is being surrounded with a polymerisable composition, in particular for heat polymerisation, cold polymerisation or auto-polymerisation, or said composition is being applied to the film, for producing the inner tooth portion of a prosthesis. Subsequently, the composition can be subjected to heat polymerisation because of the selected melting range of the film.

Alternatively, the film can be applied, in particular can be pulled on or shrunk, onto a part of a prosthesis in a mounting procedure in order to subsequently apply at least one further tooth layer onto the film.

According to the inventive method, the film is integrated, at least in part, into the dental prosthesis.

The materials of the films, of the inner tooth portion, and of the at least one further tooth layer can be formed of the materials described above.

Another subject matter of the invention is a method, in which a dental prosthesis with an integrated film is produced, in particular a tooth comprising an inner tooth portion that is provided, at least in part, with a film layer is produced, whereby the film layer is covered, at least in part, by at least one further tooth layer, in particular by a veneer.

Another subject matter of the invention is the use of a film for producing prostheses with integrated film. According to a further alternative, a subject matter of the invention is the use of films, in particular of tough-elastic and/or thermoplastic or plastic films, for producing prefabricated tooth replacements, crowns, veneers or bridges with integrated film. Moreover, the films are preferably opaque and/or tinted. Preferably, the films comprise a yellow hue.

Tough-elastic films shall be understood to be films that can change their extension when exposed to a force and are restored, at least in part, to their original shape when said force seizes to act. Preferably, tough-elastic films can be produced from PVC, polyacrylates, PE, PP, polystyrene, polybutadiene-containing materials, etc. Preferably, the tough-elastic films can be produced from elastomers. Elastomers comprise natural rubber, polybutadiene-containing polymers, polystyrene-containing polymers as well as silicone rubber. Plastically-deformable films shall be understood to be films that show irreversible deformation in response to applied loading once the load exceeds a threshold—the yield strength.

Another subject matter of the invention is one prosthesis or a multitude of prostheses obtainable according to a method, in particular a multitude of prefabricated tooth replacements can be produced through the integration of a film.

The invention is illustrated in more detail in the following examples without being limited to said exemplary embodiments. The invention shall also be illustrated in more detail based on the following figures.

FIG. 1a: Partially finished tooth with integrated film

FIG. 1b: Finished tooth with integrated film, no effect on the optical properties

FIG. 1c, 1d: Sectional view of a tooth with visible transparent film

FIG. 1e: Fractured tooth, frontal view

FIG. 1f: Fractured tooth, side view

FIG. 1g: Fractured tooth-fragment is still connected to the stump by the film material

FIG. 1h: Fractured tooth-fragment is still connected to the stump by the film material

FIG. 2a: Partially finished tooth with integrated coloured film

FIG. 2b: Finished tooth with integrated coloured film

FIG. 3: Schematic view of a sectional image of a prefabricated tooth replacement 0 comprising an incisor shell 1 in the form of a further tooth layer, a film layer 2, and an inner tooth portion 3.

### EXAMPLES

In the scope of the layer-wise production of artificial teeth, a film layer was introduced into a negative mould for tooth prostheses and integrated into the tooth. A modified PVC film with a thickness of 140 μm and a melting range from 120 to 170° C. was used, although other film materials capable of connecting homogeneously to the surrounding tooth material are feasible as well.

In the first step of the production, a paste based on PMMA and a methacrylate mixture was introduced into the production mould. A simple example of a suitable dough mass is a mixture of 60-70% PMMA bead polymers and 30-40% methacrylate-based monomers, and cross-linkers (e.g. methylmethacrylate and glycoldimethacrylate). This mixture was made to have a suitable viscoelastic consistency through the use of swelling processes.

After application of an additional separating film and placing the upper part of the mould, the first layer was pre-polymerised at 90° C.-120° C. The pre-polymerisation took place in a hydraulic heating press as a radical polymerisation initiated by peroxide.

After removal of the separating film, the special film to be incorporated was placed on the pre-polymerised layer and the subsequent layer was also applied either in the form of a paste or it was injected into the already closed mould using injection channels, if present. In this context, it is important to build up enough pressure in the mould and to allow the pasty material some time to act on the film during the heating phase of the mould. Approximately 3-5 minutes are sufficient until the nominal polymerisation temperature is reached. The mould can be opened once the mass present in the mould is cured. The film is firmly bonded between the 2 layers of material.

If needed, further layers can be added in like manner. After the production of the last layer of the tooth is completed, the teeth are detached from the surrounding plastic material.

The burrs remaining on the tooth due to the separating edges of the mould are subsequently removed either by means of automatic burr removal or by manual burr removal using manual polishing devices. Automatic burr removal preferably takes place by means of a laser, but can also be done using any common vibratory finishing or barrel deburring procedure.

Visual analysis of the sectioned images in FIGS. 1c and 1d clearly shows the profile of the film layer between the first tooth layer (incisor shell) and the second tooth layer (dentine). If the tooth breaks by force, the fragment remains flexibly attached to the residual tooth, as is evident from FIGS. 1g and 1h.

The fragment can be severed only by further pulling the parts apart and by tearing the film.

The modification of the teeth by the films according to the invention did not affect the aesthetic properties and did not reduce the strength of the tooth. The product meets the materials requirements of EN ISO 22112.

FIG. 3 shows a schematic view of a prefabricated tooth replacement according to the invention that was produced using a method according to the invention. The film layer 2 is integrated underneath the layer of the incisor shell 1, which corresponds to a further tooth layer. The film layer 2 is applied to the inner tooth portion 3.

1. Dental prosthesis comprising at least one layer of a film integrated into the dental prosthesis.

2. Prosthesis according to claim 1, wherein the prosthesis is at least one part of a dental restoration, a single tooth, veneer, crown, a bridge, a multi-unit bridge.

3. Prosthesis according to claim 1, wherein the prosthesis is designed layer-by-layer and at least one part of the prosthesis comprises at least one layer of a film situated on the inside.

4. Prosthesis according to claim 1, wherein the dental prosthesis is a tooth with at least one integrated film, whereby the tooth comprises at least three portions (i)-(iii):
(i) inner tooth portion,
(ii) film layer, and
(iii) at least one further tooth layer.

5. Prosthesis according to claim 4, wherein
(i) the inner tooth portion comprises at least one polymer of an (alky)acrylate, and/or of a copolymer based on (meth)acrylates and cross-linkers, and/or
(ii) the film layer comprises a tough-elastic and/or thermoplastic film, and/or
(iii) the at least one further tooth layer comprises at least one polymer of an (alkyl)acrylate, copolymer, veneer composite and/or dental veneer ceramics.

6. Prosthesis according to claim 1, wherein
(ii) the film layer comprises a film comprising PVC, acrylate, PE, PP, LDPE, HDPE, LDPP, HDPP, PUR, polycarbonate and/or a mixture comprising any one of said polymers.

7. Prosthesis according to claim 1, wherein the film is tinted.

8. Prosthesis according to claim 1, wherein the film is plasma-treated or chemically-modified on the surface.

9. Method for producing a dental prosthesis, which comprises the steps of:
1) providing a film,
2) integrating the film into the prosthesis by
a) (i) producing an inner tooth portion in a first step, (ii) applying and affixing a film at least in part to the inner tooth portion or arranging a film on the inner tooth portion in a subsequent step, and, optionally, (iii) applying at least one further tooth layer, at least in part, to the film and, optionally, to the regions of the inner tooth portion not provided with film, or
b) (i) providing at least one further tooth layer, (ii) applying a film on the further tooth layer, (iii) arranging an inner tooth portion on the film, or
c) (i) arranging a film and (ii) surrounding the film with the inner tooth portion and/or the at least one further tooth layer, or
d) (i) producing at least one part of an inner tooth portion in a first step, (ii) applying and affixing a film at least in part to the inner tooth portion or arranging a film on the inner tooth portion in a subsequent step, and, optionally, (iii) applying at least one further part of the inner tooth portion to the film and, optionally, to the regions of the inner tooth portion not provided with film.

10. Method according to claim 9, wherein the film is integrated into the dental prosthesis, at least in part.

11. Method according to claim 9, wherein the film comprises a tough-elastic and/or thermoplastic film.

12. Method according to claim 9 to 11, wherein
(i) the inner tooth portion is produced from a polymerisable composition comprising a) 50 to 90% by weight powdered polymer, and 10 to 50% by weight monomers; or
b) 0 to 50% by weight organic or inorganic filling agents;
50 to 99% by weight PMMA;
10 to 50% by weight monomers, whereby the total composition adds up to 100% by weight;
(ii) the inner tooth layer comprises a polymer of an acrylate, and/or (iii) the at least one further tooth layer comprises a polymer of an acrylate.

13. Method according to claim 9, wherein the method produces a tooth comprising an inner tooth portion that is provided, at least in part, with a film layer, and the film layer is covered, at least in part, by a further tooth layer, whereby, optionally, a multitude of prostheses, optionally prefabricated tooth replacements, is produced through the integration of a film.

14. Method according to claim 9, wherein
c) (i) arranging the film involves the film, optionally a web of film, being clamped between the respective negative moulds of one or more hollow moulds of prefabricated tooth replacements, and (ii) the film is being surrounded with the inner tooth portion and/or the at least one further tooth layer.

15. Prosthesis obtainable according to a method according to claim 9.

16. (canceled)
